(19) United States
(12) Patent Application Publication
(10) Pub. No.: US 2025/0020106 A1
(43) Pub. Date: Jan. 16, 2025

(54) VERTICAL AXIS WIND TURBINE AND FLOATING BODY

(71) Applicant: BITMAIN TECHNOLOGIES INC., Beijing (CN)

(72) Inventors: Tuo Geng, Beijing (CN); Fengjie Li, Beijing (CN); Shuangquan Hua, Beijing (CN); Qiwei Bai, Beijing (CN); Guowei Kong, Beijing (CN); Fei Wang, Beijing (CN)

(21) Appl. No.: 18/768,825

(22) Filed: Jul. 10, 2024

(30) Foreign Application Priority Data
Jul. 10, 2023 (CN) 202321800497.6

(51) Int. Cl. F03D 13/20; F03D 13/25

(52) U.S. Cl. CPC F03D 13/2005; F03D 13/256; F05B 2240/214; F05B 2240/9151; F05B 2240/91521; F05B 2240/93

(57) ABSTRACT

The present application provides a vertical axis wind turbine and a floating body. The vertical axis wind turbine includes a tower, a main shaft, a supporting rod and a blade; where the main shaft is connected with the tower, and the main shaft is provided to be rotatable around a central axis of the tower; the blade is connected to the main shaft by the supporting rod; the tower is retractable. In the present application, the tower and the blade of the vertical axis wind turbine can be contracted, or the tower and the blade can be put down after contraction, or the tower and the blade can be contracted and then stored below a deck, thus reducing the space occupied by the vertical axis wind turbine on the deck of the floating body to meet different operation requirements of the floating body.

### CROSS-REFERENCE TO RELATED APPLICATIONS

This application claims priority to Chinese Patent Application No. 202321800497.6, filed on Jul. 10, 2023, which is hereby incorporated by reference in its entirety.

### TECHNICAL FIELD

The present application relates to the field of wind power generation technologies and, in particular, to a vertical axis wind turbine and a floating body.

### BACKGROUND

At present, vertical axis wind turbines may be provided on floating bodies such as offshore platforms and ships to provide electric energy for the latter. The electric energy provided by the vertical axis wind turbine may be used as the propulsion power for the floating body, or as the operation and/or living electricity of the floating body.

However, because the vertical axis wind turbine usually has the characteristics of occupying the large ground and space volume, when provided on the deck of the floating body, the vertical axis wind turbine occupies a lot of space, which affects the operation and stability of the floating body. So, how to reduce the space occupied by the vertical axis wind turbine on the floating body to meet the operation requirements of the floating body is an urgent problem to be solved.

### SUMMARY

The present application provides a vertical axis wind turbine and a floating body to reduce the space occupied by the vertical axis wind turbine on the floating body to meet the different operation requirements of the floating body.

In a first aspect, the present application provides a vertical axis wind turbine. The vertical axis wind turbine includes a tower, a main shaft, a supporting rod and a blade. The main shaft is connected with the tower. The main shaft is provided to be rotatable around a central axis of the tower. The blade is connected to the main shaft by the supporting rod. The tower is retractable.

In some possible implementations, the tower includes a plurality of sections, which may include at least a first section and a second section. The first section is provided to be movable between a first position and a second position along the central axis of the tower. When the first section is at the first position, the first section protrudes from the second section. When the first section is at the second position, the first section is accommodated in the second section.

In some possible implementations, the tower further includes at least one lifting device equipped in at least one of the plurality of sections for driving the at least one section to move along the central axis of the tower.

In some possible implementations, a first lifting device of the at least one lifting device is equipped in the second section. When the first lifting device moves, the first lifting device comes into contact with the first section, and the first section moves between the first position and the second position through the first lifting device.

In some possible implementations, the plurality of sections may further include: a third section, which is configured to be movable between a third position and the second position along the central axis of the tower, and the third position is located between the first position and the second position; when the first section is at the first position, the first section protrudes from the third section, and drives the third section to protrude from the second section to the third position.

In some possible implementations, a second lifting device of the at least one lifting device is equipped in the second section and a third lifting device of the at least one lifting device is equipped in the third section; when the second lifting device moves, the second lifting device comes into contact with the third section, and the third section moves relative to the second section through the second lifting device; when the third lifting device moves, the third lifting device comes into contact with the first section, and the first section moves relative to the third section through the third lifting device.

In some possible implementations, the tower further includes: a locking device; when the first section is at the first position or the second position, the first section is held in its position by the locking device.

In some possible implementations, the blade may have a first state and a second state. When the blade is in the first state, there is a first distance between the blade and the main shaft. When the blade is in the second state, there is a second distance between the blade and the main shaft. The second distance is less than the first distance.

In some possible implementations, the supporting rod may be retractable along a first direction.

In some possible implementations, the vertical axis wind turbine may further include a base. The base is hinged to the tower. The base is used for installation of the vertical axis wind turbine.

In some possible implementations, the base is provided to be installable on a mounting base and rotatable relative to a central axis of the mounting base.

In a second aspect, the present application provides a floating body. The floating body includes a main body and the vertical axis wind turbine as described in the first aspect and any implementation thereof. The main body is provided with a deck; the vertical axis wind turbine is installed on the deck.

In some possible implementations, the vertical axis wind turbine may be provided to move between a fourth position and a fifth position. At the fourth position, the vertical axis wind turbine is upright on the deck of the floating body. At the fifth position, the vertical axis wind turbine is accommodated in a storage space located below the deck in the main body.

According to the present application, by contracting the tower and the blade of the vertical axis wind turbine, or putting down the vertical axis wind turbine down after contraction, or contracting and then storing the vertical axis wind turbine below the deck, the space occupied by the vertical axis wind turbine on the deck of the floating body can be reduced. On the one hand, the reduction of space occupied by the vertical axis wind turbine can avoid affecting the operation on the floating body and enhance the passing ability of the floating body. On the other hand, the reduction of space occupied by the vertical axis wind turbine can also cause the lowering of the center of gravity of the floating body, thus reducing the possibility of overturning of the floating body and improving the operation stability of the floating body. In addition, in a case of extreme weather, contracting the vertical axis wind turbine can also compact the structure, reduce the force thereon, and enhance the safety of the vertical axis wind turbine.

It should be understood that the general description above and the detailed description below are only for example and illustrative purposes and do not limit the present application.

### BRIEF DESCRIPTION OF DRAWINGS

The drawings herein are incorporated into and form a part of the specification, which shows embodiments in accordance with the present application, and are used together with the specification to explain the principle of the present application.

FIG. 1 is a structure diagram of a vertical axis wind turbine in an embodiment of the present application.

FIG. 2 is a structure diagram of a first example of a tower in an embodiment of the present application.

FIG. 3 is a schematic diagram of the tower in FIG. 2 in a shortened state.

FIG. 4 is a structure diagram of a second example of a tower in an embodiment of the present application.

FIG. 5 is a schematic diagram of the tower in FIG. 4 in a shortened state.

FIG. 6 is a structure diagram of a first example of a lifting device in an embodiment of the present application.

FIG. 7 is a structure diagram of a second example of a lifting device in an embodiment of the present application.

FIG. 8 is a schematic diagram of configuration of a blade of a vertical axis wind turbine in an embodiment of the present application.

FIG. 9 is a schematic diagram of the blade in FIG. 8 in a second state.

FIG. 10 is a structure diagram of a first example of a base of a vertical axis wind turbine in an embodiment of the present application.

FIG. 11 is a structure diagram of a connection between a base and a tower in an embodiment of the present application.

FIG. 12 is a structure diagram of a second example of a base of a vertical axis wind turbine in an embodiment of the present application.

FIG. 13 is a schematic diagram of a first example of a vertical axis wind turbine arranged on a floating body in an embodiment of the present application.

FIG. 14 is a schematic diagram of a second example of a vertical axis wind turbine arranged on a floating body in an embodiment of the present application.

FIG. 15 is a schematic diagram of a vertical axis wind turbine at a fourth position in an embodiment of the present application.

FIG. 16 is a schematic diagram of a first example of a vertical axis wind turbine in a fifth position in an embodiment of the present application.

FIG. 17 is a schematic diagram of a second example of a vertical axis wind turbine in a fifth position in an embodiment of the present application.

Reference signs in figures are as follows:

1, vertical axis wind turbine; 2, floating body; 10, tower; 11, first section; 12, second section; 13, third section; 14, lifting device; 141, first supporting plate; 142, lifting shaft; 1421, first shaft section; 1422, second shaft section; 143, second supporting plate; 144, shear-fork type lifting wall; 20, main shaft; 21, main body; 211, deck; 22, first region; 23, storage space; 30, supporting rod; 31, first supporting sub-rod; 32, second supporting sub-rod; 40, blade; 50, base; 51, basement; 511, groove; 52, mounting base; X, central axis of tower; and Y, central axis of mounting base.

### DESCRIPTION OF EMBODIMENTS

In the following description, in order to fully understand embodiments of the present application, specific details such as structure, device, and technology are presented for the purpose of illustration rather than limitation. However, it should be clear for those person skilled in the art that technical solutions of the present application may also be realized in other embodiments without these specific details. In other cases, detailed descriptions of well-known structure, device, and method are omitted so as to prevent unnecessary details from impeding the description of embodiments of the present application.

Floating body such as offshore platforms and ships is increasingly using clean energy to provide electric energy. In many cases, a floating body may be provided with a wind turbine (namely a wind motor) to provide electric energy, thus reducing carbon emission and fossil energy consumption to enhance economy. The electric energy provided by a wind turbine can be used as the operation and/or living electricity of the floating body, and can even be used as a propulsion power for the floating body.

Vertical axis wind turbine is more and more widely used in floating body because of its simple structure and high power. However, the vertical axis wind turbine currently used on the floating body still has the following disadvantages.

1, the vertical axis wind turbine occupies a certain space on a deck of the floating body. This inevitably affects the normal operation on the floating body. For example, in a process of lifting goods by a crane, the boom of the crane needs to avoid the vertical axis wind turbine. This undoubtedly increases the difficulty of operation on the floating body.

2, the vertical axis wind turbine itself still has a large height. The vertical axis wind turbine erected on the deck of the floating body naturally raise the overall center of gravity of the floating body, which is not conducive to stability of the floating body on the water surface.

3, when encountering bad weather such as typhoon and rainstorm, the vertical axis wind turbine on the floating body is prone to suffer a large applied loading, which may cause overturning of the vertical axis wind turbine or damage to blades of the vertical axis wind turbine.

So, how to reduce the space occupied by the vertical axis wind turbine on the floating body to meet the operation requirements of the floating body is an urgent problem to be solved.

In view of this, embodiments of the present application provide a vertical axis wind turbine.

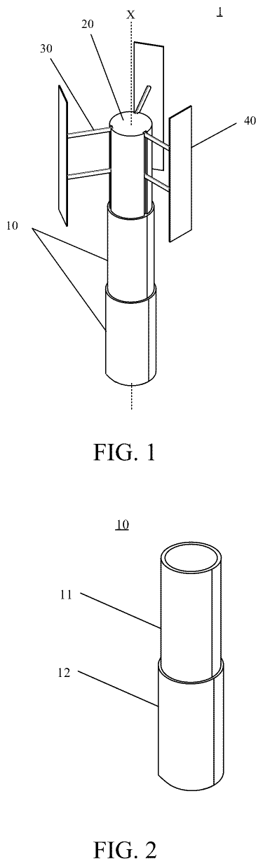

In some possible implementations, FIG. 1 is a structure diagram of a vertical axis wind turbine in an embodiment of the present application. As shown in FIG. 1, a vertical axis wind turbine 1 includes a tower 10, a main shaft 20, a supporting rod 30 and a blade 40. The main shaft 20 is connected with the tower 10, and the main shaft 20 is provided to be rotatable around a central axis X of the tower 10. Therefore, a central axis of the main shaft 20 (not shown) may coincide with the central axis X of the tower 10, and the main shaft 20 may rotate around the central axis X of the tower 10 by rotating on its own central axis. An end of the tower 10 away from the main shaft 20 may be connected with an external structure part (e.g. a deck on a floating body). The blade 40 is connected to the main shaft 20 through a supporting rod 30, and when the main shaft rotates relative to the tower, the supporting rod 30 and the blade 40 are also driven to rotate relative to the tower 10.

The tower 10 is cylindrical, and the cross-section of the tower 10 may have a profile of a circle, oval, square, rectangular or other shape.

The tower 10 is retractable. Specifically, the tower 10 may include a plurality of sections along an extension direction of the central axis X, which may include at least a first section and a second section. The first section and the second section are any two adjacent sections in the plurality of sections, that is, the first section and the second section may be nested within each other to achieve extension and contraction of the tower 10.

In an embodiment, the first section is provided to be movable between a first position and a second position along the central axis of the tower 10. When the first section is at the first position, the first section protrudes from the second section. When the first section is at the second position, the first section is accommodated in the second section.

The following takes the tower 10 includes two sections, namely the first section and the second section, as an example to explain the tower 10.

In an embodiment, FIG. 2 is a structure diagram of a first example of a tower in an embodiment of the present application. As shown in FIG. 2, the tower 10 may include the first section 11 and the second section 12. A diameter of the first section 11 is less than a diameter of the second section 12. The first section 11 is provided to be movable between the first position and the second position along the central axis X of the tower 10 relative to the second section 12.

As shown in FIG. 2, when the first section 11 is at the first position, the first section 11 protrudes from the second section 12. When the first section 11 is at the first position, the first section 11 elongates to a maximum degree, and the tower 10 is at a maximum length. At this time, it may be considered that the tower 10 is in an extended state. The first position is a position where the first section 11 and the second section 12 are in the state of their centers being farthest away from each other.

In an embodiment, when the first section 11 is at the first position, the first section 11 may partially or completely protrude from the second section 12.

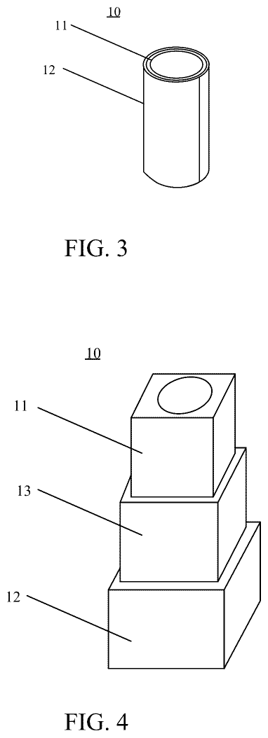

FIG. 3 is a schematic diagram of the tower in FIG. 2 in a shortened state. As shown in FIG. 3, when the first section 11 is at the second position, the first section 11 is accommodated in the second section 12. When the first section 11 is at the second position, the first section 11 is in a greatest degree of contraction, and the length of the tower 10 is the smallest. At this time, it may be considered that the tower 10 is in a shortened state. The second position is a position where the first section 11 and the second section 12 are in the state of their centers being nearest to each other.

In an embodiment, when the first section 11 is at the second position, the first section 11 may be completely accommodated in the second section 12.

The following takes the tower 10 including three sections, namely the first section, the second section and a third section as an example to illustrate the tower 10.

In an embodiment, FIG. 4 is a structure diagram of a second example of a tower in an embodiment of the present application. As shown in FIG. 4, the tower 10 may include the first section 11, the second section 12 and a third section 13. The diameter of the first section 11 is less than a diameter of the third section 13. The diameter of the third section 13 is less than the diameter of the second section 12. The first section 11 is provided to be movable between the first position and the second position along the central axis X of the tower 10. The third section 13 is provided to be movable between a third position and the second position along the central axis X of the tower 10. The third position is between the first position and the second position.

As shown in FIG. 4, when the first section 11 is at the first position, the first section 11 protrudes from the third section 13, and drives the third section 13 to protrude from the second section 12. When the first section 11 is at the first position, the third section 13 is at the third position, both the first section 11 and the third section 13 elongate to a maximum degree relative to the second section 12, and the tower 10 is at a maximum length. At this time, it may be considered that the tower 10 is in an extended state. The first position is a position where the first section 11 and the second section 12 are in the state of their centers being farthest away from each other. The third position is a position where the third section 13 and the second section 12 are in the state of their centers being farthest away from each other.

It may be understood that the first section 11 is adjacent to the third section 13, and the third section 13 is adjacent to the second section 12. When it is realized that the first section 11 protrudes from the third section 13 and the third section 13 protrudes from the second section 12, the first section 11 is at the first position relative to the third section 13, and the third section 13 is at the first position relative to the second section 12, that is, “the first section 11 being at the first position” in the above embodiment may be understood as that the first section 11 is at the first position relative to the third section 13, and “the third section 13 being at the third position” may be understood as that the third section 13 is at the first position relative to the second section 12.

In an embodiment, when the first section 11 is at the first position, the first section 11 may partially or completely protrude from the third section 13 and the third section 13 may partially or completely protrude from the second section 12; when the third section 13 is at the third position, the third section 13 may partially or completely protrude from the second section 12.

It should be noted that in actual use, whether the first section 11 is at the first position has nothing to do with whether the third section 13 is at the third position. The positions of the first section 11 and the third section 13 may be controlled according to actual requirements, which is not specified in embodiments of the present application.

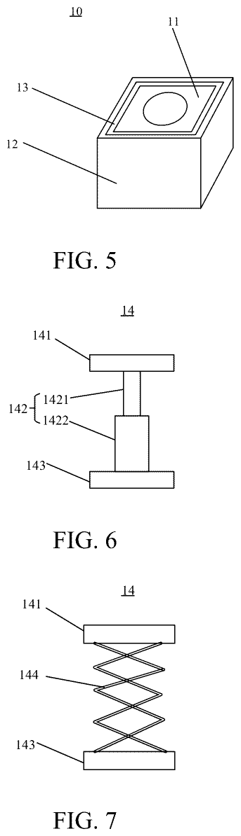

FIG. 5 is a schematic diagram of the tower in FIG. 4 in a shortened state. As shown in FIG. 5, when the first section 11 is at the second position, the first section is accommodated in the second section 12, and drives the third section 13 to be accommodated in the second section 12. When the first section is at the second position, the first section 11 and the third section are both in the greatest degree of contraction relative to the second section 12, and the length of the tower 10 is the smallest. At this time, it may be considered that the tower 10 is in a shortened state. The second position is a position where the first section 11 and the second section 12 are in the state of their centers being nearest to each other.

In an embodiment, when the first section 11 is at the second position, the first section 11 and the third section 13 may be completely accommodated in the second section 12.

It may be understood that the first section 11 is adjacent to the third section 13, and the third section 13 is adjacent to the second section 12. When it is realized that the first section 11 is accommodated in the third section 13 and the third section 13 is accommodated in the second section 12, the first section 11 is at the second position relative to the third section 13, and the third section 13 is at the second position relative to the second section 12, that is, “the first section 11 being at the second position” in the above embodiment may be understood as that the first section 11 is at the second position relative to the third section 13, and “the third section 13 being at the second position” may be understood as that the third section 13 is at the second position relative to the second section 12.

In some possible implementations, the tower 10 further includes at least one lifting device equipped in at least one of the plurality of sections for driving the at least one section to move along the central axis of the tower.

It may be understood that a first lifting device of the at least one lifting device may be equipped in the second section of the plurality of sections. When the first lifting device moves, the first lifting device comes into contact with the first section, and the first section moves between the first position and the second position through the first lifting device.

In some possible implementations, when the tower 10 is of the structure shown in FIG. 2, the second section 12 of the tower 10 is further equipped with the first lifting device. Through the first lifting device, the first section 11 can move between the first position and the second position relative to the second section 12. The first lifting device may be accommodated in the second section 12 for supporting the movement of the first section 11.

In an embodiment, the first lifting device has two opposite ends, with a first end being connected with the first section 11 and a second end being fixedly connected with the second section 12. In actual use, the first lifting device may be driven by a drive motor to make its first end move away from the second end, while driving the first section 11 to move to the first position; the lifting device 14 may also be driven by the drive motor to make its first end move close to the second end, while driving the first section 11 to move to the second position.

In some possible implementations, when the tower 10 is of the structure shown in FIG. 4, the second section 12 of the tower 10 is further equipped with a second lifting device (i.e. the first lifting device in above embodiment), and the third section 13 of the tower 10 is further equipped with a third lifting device. Through the second lifting device, the third section 13 can move between the third position and the second position relative to the second section 12. Through the second lifting device and the third lifting device, the first section 11 can move between the first position and the second position relative to the second section 12.

It should be noted that the second lifting device and the third lifting device may be same or different lifting devices, which is not specified in embodiments of the present application.

In an embodiment, the second lifting device has two opposite ends, with a first end being connected with the third section 13 and a second end being fixedly connected with the second section 12. The third lifting device has two opposite ends, with a first end being connected with the first section 11 and a second end being fixedly connected with the third section 13.

In actual use, the second lifting device may be driven by a drive motor to make its first end move away from the second end, while driving the third section 13 to move to the third position; the third lifting device may also be driven by a drive motor to make its first end move away from the second end, while driving the first section 11 move to the first position. In addition, the second lifting device may also be driven by the drive motor to make its first end move close to the second end, while driving the third section 13 to move to the second position; the third lifting device may also be driven by the drive motor to make its first end move close to the second end, while driving the first section 11 to move to the second position.

In an embodiment, the second lifting device and the third lifting device are a same lifting device, which may be generalized as a fourth lifting device. The fourth lifting device has two opposite ends, with a first end being connected with the first section 11 and the second end being fixedly connected with the second section 12.

In actual use, the fourth lifting device may be driven by a drive motor to make its first end move away from the second end, while driving the first section 11 to move to the first position; the movement of the first section 11 to the first position drives the third section 13 to move to the third position. In addition, the fourth lifting device may also be driven by the drive motor to make its first end move close to the second end, while driving the first section 11 to move to the second position; the movement of the first section 11 to the second position drives the third section 13 to move to the second position.

From the above embodiments, it may be seen that when the tower has more than two sections, there may be multiple lifting devices, which are in the second section, the third section, . . . , and the Nth section respectively for supporting the movement of the first section, the second section, . . . , (N-1)th section. Or, there may be only one lifting device, accommodated in the section at the bottom of the tower. The first end of the lifting device is fixedly connected with that section, and the other end successively supports the movement of the first section, the second section,., and the (N-1)th section.

In an embodiment, FIG. 6 is a structure diagram of a first example of a lifting device in an embodiment of the present application. The lifting device 14 may be the first lifting device, the second lifting device, the third lifting device or the fourth lifting device in the above embodiments. The lifting device 14 includes: a first supporting plate 141, a lifting shaft 142 and a second supporting plate 143. The first supporting plate 141 is connected with the first section 11, the second supporting plate 143 is fixedly connected with the second section 12, and two ends of the lifting shaft 142 are respectively connected with the first supporting plate 141 and the second supporting plate 143. The lifting shaft 142 includes at least: a first shaft section 1421 and a second shaft section 1422, a diameter of the first shaft section 1421 is less than a diameter of the second shaft section 1422, and the first shaft section 1421 may be partially or completely accommodated in the second shaft section 1422.

In actual use, the drive motor may drive the first shaft section 1421 to move relative to the second shaft section 1422, so that the first shaft section 1421 partially or completely protrudes from the second shaft section 1422, so as to realize the movement of the first end of the lifting device 14 away from the second end, driving the first section 11 to move to the first position. The drive motor may also drive the first shaft section 1421 to move relative to the second shaft section 1422, so that the first shaft section 1421 is fully accommodated in the second shaft section 1422, so as to realize the movement of the first end of the lifting device 14 close to the second end, driving the first section 11 to move to the second position.

In an embodiment, FIG. 7 is a structure diagram of a second example of a lifting device in an embodiment of the present application. The lifting device 14 includes the first supporting plate 141, a shear-fork type lifting wall 144 and the second supporting plate 143. The first supporting plate 141 is connected with the first section 11, the second supporting plate 143 is fixedly connected with the second section 12, and two ends of the shear-fork type lifting wall 144 are respectively connected with the first supporting plate 141 and the second supporting plate 143.

In actual use, the drive motor may drive the shear-fork type lifting wall 144 to unfold from a folded state to a non-folded state, so that the first end of the lifting device 14 moves away from the second end, driving the first section 11 to move to the first position. The drive motor may also drive the shear-fork type lifting wall 144 to shrink from a non-folded state to a folded state, so that the first end of the lifting device 14 moves close to the second end and drives the first section 11 to move to the second position.

It should be noted that the lifting device 14 in embodiments shown in FIG. 6 and FIG. 7 may also adopt other structures according to actual requirements, which are not specified in embodiments of the present application. The lifting device 14 in embodiments shown in FIG. 6 and FIG. 7 may also be driven to move by air pressure or hydraulic pressure, which is not specified in embodiments of the present application.

In some possible implementations, in order to fix the first section 11 to the first position or the second position and maintain the stability of the relative position of the first section 11 in relation to the second section 12, so as to maintain the height required for the operation of the vertical axis wind turbine, a locking device may be equipped in the tower 10.

In an embodiment, when the tower has only two sections, the locking device may be provided at the first end and/or the second end of the second section 12; The first end and the second end are opposite ends of the second section 12 along the lifting direction of the vertical axis wind turbine 1. When the first section 11 moves to the first position, the first section 11 is locked with the locking device at the first end of the second section 12; when the first section 11 moves from the first position to the second position, the first section 11 is unlocked from the locking device at the first end of the second section 12; when the first section 11 moves to the second position, the first section 11 is locked with the locking device at the second end of the second section 12.

The locking device may be set to be of a variety of structures such as a mechanical structure and a magnetic structure according to actual requirements, which are not specified in embodiments of the present application. For example, the first section 11 may be provided with a convex part, and the first end of the second section 12 may be provided with a locking device (which may be a clamping slot), and when the convex part of the first section 11 slides towards the first position to the clamping slot, the first section 11 and the second section 12 are locked; when the first section 11 is pulled out of the clamping slot under a force, the first section 11 is unlocked from the locking device at the first end of the second section 12.

In an embodiment, when the tower has more than two sections, the locking device may also be provided in the second section 12, the third section 13, for locking the first section 11 with the third section 13 and locking the third section 13 with the second section 12. Reference for the specific structure of the locking device may be made to the description in an embodiment where the tower has only two sections, which will not be detailed here for concision of specification.

In some possible implementations, in order to meet the different operation requirements of the floating body, the blade 40 may have a first state and a second state. When the blade 40 is in the first state, there is a first distance between the blade 40 and the main shaft 20, and the blade 40 may be considered to be in an extended state; when the blade 40 is in the second state, there is a second distance between the blade 40 and the main shaft 20, and the second distance is less than the first distance, then the blade 40 may be considered to be in a contracted state. Compared with the first distance between the blade 40 and the main shaft 20, the second distance between the blade 40 and the main shaft 20 takes up less space, which can avoid affecting the operation on the floating body.

The blade 40 may realize the transformation between the extended state and the contracted state through the supporting rod 30. Specifically, the blade 40 is connected to the main shaft 20 through the supporting rod 30, and when the supporting rod 30 is a retractable structural part, the blade 40 may change its state (the extended state and the contracted state) according to the change of the state (the extended state or the contracted state) of the supporting rod 30.

Here, the supporting rod 30 is a retractable structural part, which usually means that the supporting rod 30 is retractable in a first direction. The first direction refers specifically to a direction in which the blade 40 travels to the main shaft 20. When the supporting rod 30 is retractable in the first direction, the blade 40 can change its distance from the main shaft 20 accordingly, thus changing to the first state or the second state.

In an embodiment, the supporting rod 30 is itself retractable. The supporting rod 30 has a first end and a second end, and the first end and the second end may get close to or away from each other in the first direction. For example, the supporting rod 30 may be of a retractable rod structure. In actual use, the first end of the supporting rod 30 is connected to the blade 40, and the second end is connected to the main shaft 20. The retraction or extension is implemented through the first end getting close to or away from the second end.

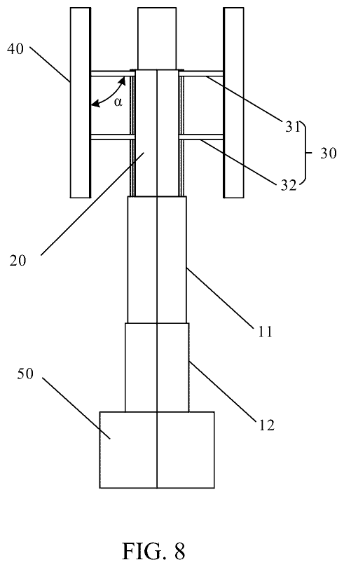

In an embodiment, the retraction and extension of the supporting rod 30 is implemented by an external structural part. FIG. 8 is a schematic diagram of configuration of a blade of a vertical axis wind turbine in an embodiment of the present application. As shown in FIG. 8, the vertical axis wind turbine 1 may have three blades 40, each of which is connected to the main shaft 20 through a supporting rod 30. The supporting rod 30 has at least a first supporting sub-rod 31 and a second supporting sub-rod 32, and the first supporting sub-rod 31 and the second supporting sub-rod 32 are provided in parallel. One end of each of the first supporting sub-rod 31 and the second supporting sub-rod 32 is connected with the main shaft 20 in a sliding manner, and the other end of each of the first supporting sub-rod 31 and the second supporting sub-rod 32 is hinged to the blade 40.

As shown in FIG. 8, each of the first supporting sub-rod 31 and the second supporting sub-rod 32 is at a first sliding position, and each of the first supporting sub-rod 31 and the second supporting sub-rod 32 is in a first angle α with a plane where the blade 40 is located. The first supporting sub-rod 31 and the second supporting sub-rod 32 are in the extended state, and the blade 40 is in the first state.

Here, the blade 40 is in the first state and has a far first distance from the main shaft 20, which can increase the torque between the blade 40 and the main shaft 20 to improve the power generation efficiency.

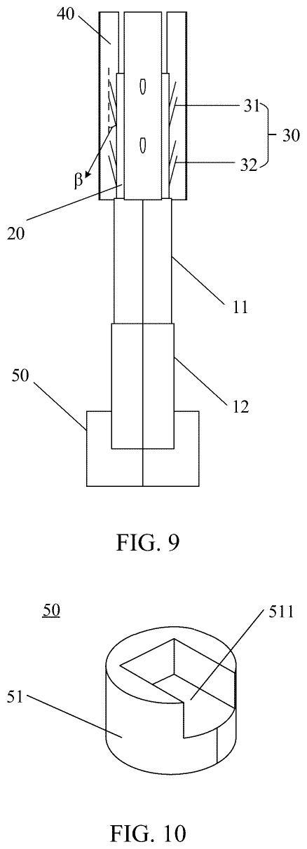

FIG. 9 is a schematic diagram of the blade in FIG. 8 in a second state. As shown in FIG. 9, each of the first supporting sub-rod 31 and the second supporting sub-rod 32 is at a second sliding position, and each of the first supporting sub-rod 31 and the second supporting sub-rod 32 is in a second angle β with the plane where the blade 40 is located (the plane where the dashed line is located in FIG. 9). The first supporting sub-rod 31 and the second supporting sub-rod 32 are in the contracted state, and the blade 40 is in the second state.

Compared with the blade 40 in the first state, the blade 40 in the second state has a second distance from the main shaft 20. Since the second angle β is less than the first angle α, the second distance is less than the first distance.

It may be understood combined with FIG. 8 and FIG. 9 that one end of each of the first supporting sub-rod 31 and the second supporting sub-rod 32 slides from the first sliding position to the second sliding position, driving one end of the first supporting sub-rod 31 and the second supporting sub-rod 32 to slide downward to realize contraction of the supporting rod 30 towards the direction of the main shaft 20. At the same time, through the hinged structure between the first supporting sub-rod 31, the second supporting sub-rod 32 and the blade 40, the angle between each of the first supporting sub-rod 31 and the second supporting sub-rod 32 and the plane where the blade 40 is located is reduced from the first angle to the second angle, reducing the space occupied by the vertical axis wind turbine while maintaining the parallelism of the blade 40 to the main shaft 20, and avoiding collision between the blades 40 caused by the contraction of the supporting rods 30.

It should be noted that the sliding connection structure between the supporting rod 30 and the main shaft 20 in embodiments shown in FIG. 8 and FIG. 9, and the hinge connection structure between the supporting rod 30 and the blade 40 may be provided according to actual requirements, which are not specified in embodiments of the present application. For example, the sliding connection structure may be a sliding-and-rail structure, and the hinge connection structure may be a hinge structure.

It should be noted that the sliding connection structure between the supporting rod 30 and the main shaft 20 in embodiments in FIG. 8 and FIG. 9 may also be a hinge connection structure. For example, the supporting rod 30 may be rotated by the hinge connection structure so that one end and the other two ends coincide in the first direction, thus reducing the distance from one end to the other two ends to achieve the contraction of the blade 40.

In an embodiment, the difference from the embodiments shown in FIG. 8 and FIG. 9 is only that there is only the first supporting sub-rod 31 in a supporting rod. The blade 40 is connected with the main shaft 20 through the first supporting sub-rod 31 which, when contracted in a sliding manner, drives the blade 40 to contract.

In an embodiment, the difference from the embodiments shown in FIG. 8 and FIG. 9 is only that the sliding directions of the first supporting sub-rod 31 and the second supporting sub-rod 32 in the supporting rod 30 are different. The second supporting sub-rod 32 slides downward from the first sliding position to the second sliding position, which is the same as the movement direction of the second supporting sub-rod 32 as shown in FIG. 8 and FIG. 9. The first supporting sub-rod 31 slides upward from the first sliding position to the second sliding position, which is opposite to the movement direction of the first supporting sub-rod 31 as shown in FIG. 8 and FIG. 9.

In an embodiment, the difference from the embodiments shown in FIG. 8 and FIG. 9 is only that the sliding directions of the first supporting sub-rod 31 and the second supporting sub-rod 32 in the supporting rod 30 are different. The first supporting sub-rod 31 slides downward from the first sliding position to the second sliding position, which is the same as the movement direction of the first supporting sub-rod 31 as shown in FIG. 8 and FIG. 9. The second supporting sub-rod 32 slides upward from the first sliding position to the second sliding position, which is opposite to the movement direction of the second supporting sub-rod 32 as shown in FIG. 8 and FIG. 9.

In some possible implementations, the vertical axis wind turbine 1 further includes: a base 50, where one end of the base 50 is connected with the tower 10 for installation of the tower 10 and other components in the vertical axis wind turbine 1, and the other end is fixedly connected with the floating body for the tower 10 to connect with the floating body.

In an embodiment, FIG. 10 is a structure diagram of a first example of a base of a vertical axis wind turbine in an embodiment of the present application. As shown in FIG. 10, the base 50 includes: a basement 51, and a part of the side wall of the basement 51 is provided with a groove 511. The groove 511 is used to accommodate part of the tower 10 for convenient installation of the tower 10.

For example, an end of the tower 10 may protrude into the groove 511 and is in detachable connection with the basement 51 by connecting pieces. Here, the specific structure of connecting pieces may be provided according to actual requirements, which is not specified in embodiments of the present application.

For example, an end of the tower 10 may protrude into the groove 511 and the hinge joint between the tower 10 and the basement 51 may be implemented by hinging pieces arranged at the groove 511. Here, the hinging pieces may be a hinge, a bearing and other structures, and the specific structure of the hinging pieces may be provided according to actual requirements, which is not specified in embodiments of the present application.

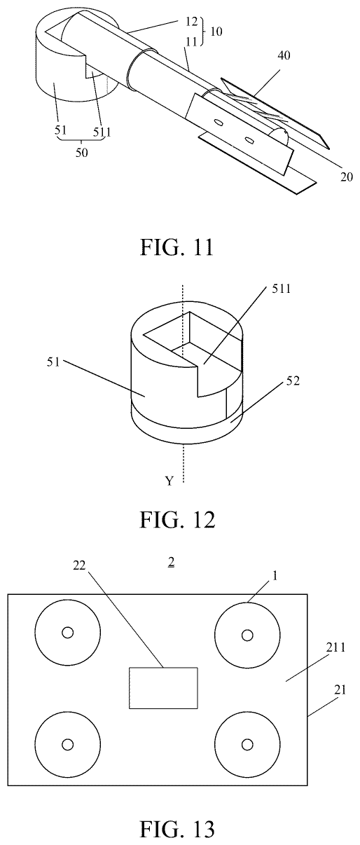

FIG. 11 is a structure diagram of a connection between a base and a tower in an embodiment of the present application. As shown in FIG. 11, the tower 10 is hinged to the base 50, and the tower 10 can rotate relative to the base 50, and the direction of rotation is determined by the notch generated for the groove 511 formed at the basement 51. In particular, when the vertical axis wind turbine 1 works, the tower 10 is upright, and its central axis is perpendicular to a bottom surface of the groove 511; when the vertical axis wind turbine 1 finishes working, the tower 10 is rotated such that the side wall of the tower 10 fits the bottom surface of the groove 511, so that the tower is put down for convenient storage.

In addition, when the tower 10 is hinged to the base 50, the base 50 should also be provided with a locking structure to achieve the stability of the upright tower 10. The locking structure may be a mechanical structure or a magnetic structure, which may be selected according to actual acquirements.

In an embodiment, FIG. 12 is a structure diagram of a second example of a base of a vertical axis wind turbine in an embodiment of the present application. As shown in FIG. 12, a mounting base 52 is added on the basis of the embodiment shown in FIG. 10. The basement 51 and the mounting base 52 are provided in an overlapping manner. The mounting base 52 is fixedly connected with the floating body. Here, the mounting base 52 may be fixed on the floating body in advance through a fixed connection. Then, by installing the basement 51 on the mounting base 52, the vertical axis wind turbine 1 can be installed on the floating body, so as to facilitate the disassembly of the vertical axis wind turbine 1 and the floating body. The basement 51 may be rotated relative to the central axis of the mounting base 52. For this purpose, the central axis of basement 51 (not shown) may coincide with a central axis Y of the mounting base 52, and the rotation of basement 51 around the central axis Y of the mounting base 52 may be achieved by rotating on its own central axis. The connection between the basement 51 and the mounting base 52 may be realized by a rotating connection structure, such as bearings, rotating fasteners and other structures, which is not specified in embodiments of the present application.

It should be noted that the basement 51 rotates around the central axis of the mounting base 52, which can drive the groove 511 to rotate relative to the floating body, so that during storing the structural parts such as the tower 10, the groove 511 drives the tower 10 to rotate, thus implementing the storing of the tower 10 in any selected direction on the floating body.

Based on the same inventive idea, the present application embodiments also provide a floating body. The floating body may be a platform for offshore operations, a ship, etc. The vertical axis wind turbine as shown in any of the embodiments in FIG. 1 to FIG. 12 above may be mounted on the floating body.

In some possible embodiments, FIG. 13 is a schematic diagram of a first example of a vertical axis wind turbine arranged on a floating body in an embodiment of the present application. As shown in FIG. 13, a floating body 2 includes a main body 21 and the vertical axis wind turbine 1 connected with the main body 21. Reference for the specific structure of the vertical axis wind turbine 1 may be made to the description in any of the embodiments corresponding to FIG. 1 to FIG. 12, and details will not be repeated here for the sake of brevity of the specification.

In an embodiment, at least a deck 211 is provided on the main body 21, and the vertical axis wind turbine 1 may be connected with the main body 21 through the deck 211. The position of the vertical axis wind turbine 1 on the main body 21 may be selected according to the layout of the deck 211, which is not specified in embodiments of the present application.

In an embodiment, the main body 21 of the floating body 2 has a first region 22 where goods, such as transport goods, are stored. The vertical axis wind turbine 1 may be provided on the deck 211 around the first region 22, thus avoiding the impact on working on the goods in the first region 22.

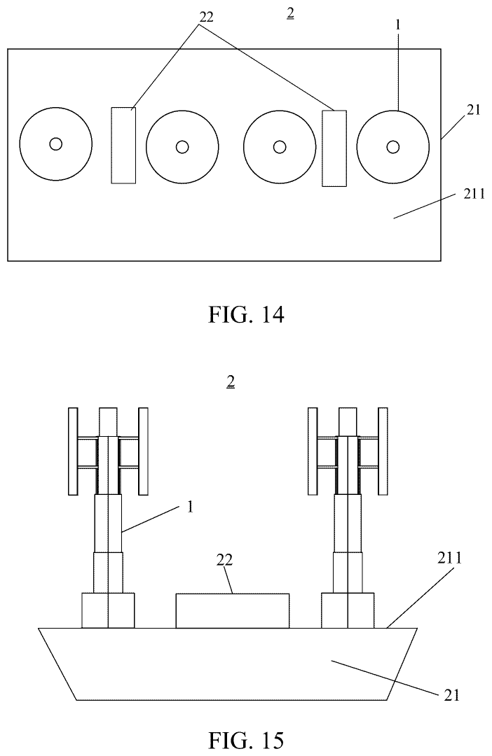

In an embodiment, FIG. 14 is a schematic diagram of a second example of a vertical axis wind turbine arranged on a floating body in an embodiment of the present application. As shown in FIG. 14, based on the location of the first region 22, the vertical axis wind turbines 1 on the floating body 2 may be provided in a row on the deck 211, thus avoiding the impact on working on the goods in the first region 22.

In some possible implementations, according to operation requirements of the float body 2, the vertical axis wind turbine 1 on the float body 2 may be provided to move between a fourth position and a fifth position. At the fourth position, the vertical axis wind turbine 1 is upright on the deck 211 of the floating body. Here, the vertical axis wind turbine 1 may start to work and supply power to the floating body 2; at the fifth position, the vertical axis wind turbine 1 is accommodated in a storage space 23 below the deck 211. Here, the vertical axis wind turbine 1 stops working, and in order to reduce the occupation of the vertical axis wind turbine 1 on the deck 211, the storage space 23 may be provided below a plane where the deck 211 is located, and the vertical axis wind turbine 1 may be lowered to be accommodated in the storage space 23.

In an embodiment, FIG. 15 is a schematic diagram of a vertical axis wind turbine at a fourth position in an embodiment of the present application. As shown in FIG. 15, the vertical axis wind turbine 1 stands upright on the deck 211 of the floating body 2. Here, the bottom of the vertical axis wind turbine 1 is connected with the deck 211, and te vertical axis wind turbine 1 protrudes out of the plane where the deck 211 is located, providing conditions for the start-up of the vertical axis wind turbine 1.

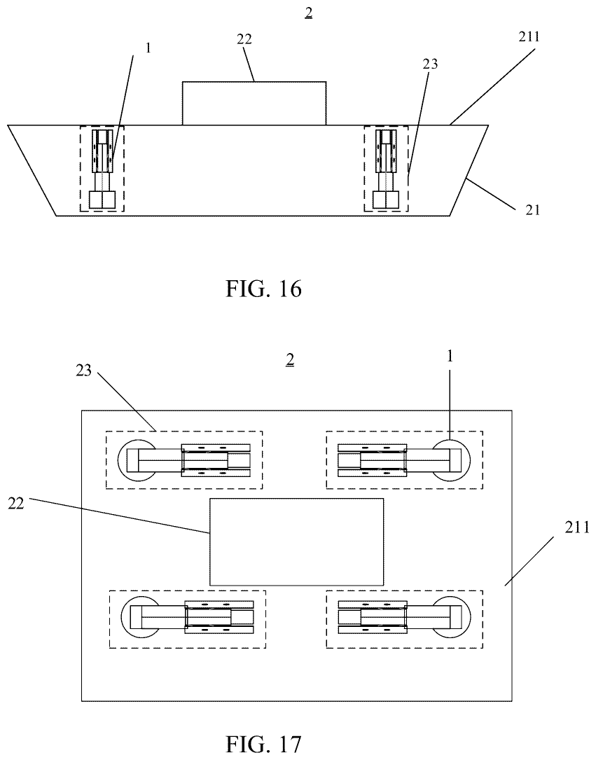

In an embodiment, FIG. 16 is a schematic diagram of a first example of a vertical axis wind turbine at a fifth position in an embodiment of the present application. As shown in FIG. 16, the vertical axis wind turbine 1 is accommodated in the storage space 23 below the deck 211. The tower 10 of the vertical axis wind turbine 1 contracts downward to continuously reduce the height. At the same time, the deck 211 connected with the vertical axis wind turbine 1 (part of the entire deck) is also continuously lowered, so that the contracted vertical axis wind turbine 1 may be accommodated in the storage space 23 below the deck 211 (the portion of the entire deck except the deck connected with the vertical axis wind turbine).

Here, the movement of the deck 211 connected with the vertical axis wind turbine 1 may be achieved by lifting components. Reference for the specific structure of the lifting components may be made to the description of the lifting devices in FIG. 6 to FIG. 7, or to the description of related technologies, and details will not be repeated here.

In an embodiment, FIG. 17 is a schematic diagram of a second example of a vertical axis wind turbine at a fifth position in an embodiment of the present application. As shown in FIG. 17, the difference from FIG. 16 is only that the vertical axis wind turbine 1 is put down and accommodated horizontally in the storage space 23 below the deck 211.

It should be noted that the vertical axis wind turbine 1 may be put down because the connection of some components in the vertical axis wind turbine 1 is provided as a detachable structure or a hinge structure, such as the connection between the base 50 and the tower 10 as shown in the embodiment in FIG. 11. Therefore, based on the connection relationship of the components in the vertical axis wind turbine 1, the vertical axis wind turbine 1 may be put down, so that the storage and accommodation of the vertical axis wind turbine 1 can be completed when the thickness of the main body 21 of the floating body 2 is limited.

According to embodiments of the present application, by contracting the tower and the blade of the vertical axis wind turbine, or putting down the vertical axis wind turbine down after contraction, or contracting and then storing the vertical axis wind turbine below the deck, the space occupied by the vertical axis wind turbine on the deck of the floating body can be reduced. On the one hand, the reduction of space occupied by the vertical axis wind turbine can avoid affecting the operation on the floating body and enhance the passing ability of the floating body. On the other hand, the reduction of space occupied by the vertical axis wind turbine can also cause the lowering of the center of gravity of the floating body, thus reducing the possibility of overturning of the floating body and improving the operation stability of the floating body. In addition, in a case of extreme weather, contracting the vertical axis wind turbine can also compact the structure, reduce the force thereon, and enhance the safety of the vertical axis wind turbine.

The above embodiments are intended only to illustrate the technical solution of the present application and not to restrict the present application. Though the detailed description is made to the present application by reference to the above embodiments, it should be understood by persons of ordinary skill in the art that modification may be made to the technical solutions described in the above embodiments or equivalent replacements may be made for some of technical features thereof. Such modification or replacement will not make the essence of corresponding technical solutions deviate from the spirit and scope of technical solutions of the embodiments of the present application, and shall be included in the protection scope of the present application.

What is claimed is:

1. A vertical axis wind turbine, comprising: a tower, a main shaft, a supporting rod and a blade; wherein
the main shaft is connected with the tower, and the main shaft is provided to be rotatable around a central axis of the tower;
the blade is connected to the main shaft by the supporting rod;
the tower is retractable.

2. The vertical axis wind turbine according to claim 1, wherein the tower comprises a plurality of sections comprising at least a first section and a second section; the first section is provided to be movable between a first position and a second position along the central axis of the tower;
wherein when the first section is at the first position, the first section protrudes from the second section; when the first section is at the second position, the first section is accommodated in the second section.

3. The vertical axis wind turbine according to claim 2, wherein the tower further comprises at least one lifting device equipped in at least one of the plurality of sections;
a first lifting device of the at least one lifting device is equipped in the second section, wherein when the first lifting device moves, the first lifting device comes into contact with the first section, and the first section moves between the first position and the second position through the first lifting device.

4. The vertical axis wind turbine according to claim 2, wherein the tower further comprises: a locking device; wherein when the first section is at the first position or the second position, the first section is held in its position by the locking device.

5. The vertical axis wind turbine according to claim 3, wherein the tower further comprises: a locking device; wherein when the first section is at the first position or the second position, the first section is held in its position by the locking device.

6. The vertical axis wind turbine according to claim 1, wherein the blade has a first state and a second state;
when the blade is in the first state, there is a first distance between the blade and the main shaft;
when the blade is in the second state, there is a second distance between the blade and the main shaft, and the second distance is less than the first distance.

7. The vertical axis wind turbine according to claim 2, wherein the blade has a first state and a second state;
when the blade is in the first state, there is a first distance between the blade and the main shaft;
when the blade is in the second state, there is a second distance between the blade and the main shaft, and the second distance is less than the first distance.

8. The vertical axis wind turbine according to claim 6, wherein the supporting rod is retractable along a first direction.

9. The vertical axis wind turbine according to claim 7, wherein the supporting rod is retractable along a first direction.

10. The vertical axis wind turbine according to claim 1, wherein the vertical axis wind turbine further comprises:
a base which is hinged to the tower and configured for installation of the vertical axis wind turbine.

11. The vertical axis wind turbine according to claim 10, wherein the base is provided to be installable on a mounting base and rotatable relative to a central axis of the mounting base.

12. A floating body, comprising:
a main body, on which a deck is provided;
a vertical axis wind turbine, wherein the vertical axis wind turbine is installed on the deck and comprises: a tower, a main shaft, a supporting rod and a blade; wherein
the main shaft is connected with the tower, and the main shaft is provided to be rotatable around a central axis of the tower;
the blade is connected to the main shaft by the supporting rod;
the tower is retractable.

13. The floating body according to claim 12, wherein the vertical axis wind turbine is provided to move between a fourth position and a fifth position;
at the fourth position, the vertical axis wind turbine is upright on the deck of the floating body;
at the fifth position, the vertical axis wind turbine is accommodated in a storage space located below the deck in the main body.

14. The floating body according to claim 12, wherein the tower comprises a plurality of sections comprising at least a first section and a second section; the first section is provided to be movable between a first position and a second position along the central axis of the tower;
wherein when the first section is at the first position, the first section protrudes from the second section; when the first section is at the second position, the first section is accommodated in the second section.

15. The floating body according to claim 14, wherein the tower further comprises at least one lifting device equipped in at least one of the plurality of sections;
a first lifting device of the at least one lifting device is equipped in the second section, wherein when the first lifting device moves, the first lifting device comes into contact with the first section, and the first section moves between the first position and the second position through the first lifting device.

16. The floating body according to claim 14, wherein the tower further comprises: a locking device; wherein when the first section is at the first position or the second position, the first section is held in its position by the locking device.

17. The floating body according to claim 12, wherein the blade has a first state and a second state;
when the blade is in the first state, there is a first distance between the blade and the main shaft;
when the blade is in the second state, there is a second distance between the blade and the main shaft, and the second distance is less than the first distance.

18. The floating body according to claim 17, wherein the supporting rod is retractable along a first direction.

19. The floating body according to claim 12, wherein the vertical axis wind turbine further comprises:
a base which is hinged to the tower and configured for installation of the vertical axis wind turbine.

20. The floating body according to claim 19, wherein the base is provided to be installable on a mounting base and rotatable relative to a central axis of the mounting base.
